(19) United States
(12) Patent Application Publication
(10) Pub. No.: US 2011/0270900 A1
(43) Pub. Date: Nov. 3, 2011

(54) DISTRIBUTED FILE NAME SOLUTION SYSTEM, DISTRIBUTED FILE NAME SOLUTION METHOD AND DISTRIBUTED FILE NAME SOLUTION PROGRAM

(76) Inventors: Yoshiaki Sakae, Tokyo (JP); Kinichi Sugimoto, Tokyo (JP); Yasuo Itabashi, Tokyo (JP); Masumi Ichien, Tokyo (JP)

(21) Appl. No.: 13/143,410

(22) PCT Filed: Dec. 25, 2009
(86) PCT No.: PCT/JP2009/071631

§ 371 Date: Jul. 6, 2011

(30) Foreign Application Priority Data
Jan. 8, 2009 (JP) 2009-002333

(51) Int. Cl. G06F 17/30

(52) U.S. Cl. 707/827; 707/E17.005; 707/E17.01

(57) ABSTRACT

In a distributed file system, the load of a meta server, and communications traffic between a client and the meta server is reduced. Specifically, each of a plurality of clients is provided with an object position calculating section and an arrangement algorithm storage section, and acquires the meta data from the meta server, and determines the objects and the storage positions of the objects (e.g. the object server IDs) through calculation on the side of the client by using an arrangement algorithm ID, the arrangement parameter corresponding to the file which is contained in the meta data.

### TECHNICAL FIELD

The present invention relates to a distributed file name solution system, a distributed file name solution method and a distributed file name solution program. Especially, the present invention relates to a distributed file name solution system, a distributed file name solution method and a distributed file name solution program, in which name solution is performed in the distributed file name solution system.

### RELATED ARTS

Examples of a conventional distributed file system in which files are distributed and stored, are described in Non-Patent Literature 1 and Non-Patent Literature 2.

As shown in FIG. 1, the conventional distributed file system is provided with clients, meta servers and storages. Here, the client is an inquiry unit. The meta server is a name solution unit. The storage is a data storage unit. The name solution unit retains a file, objects configuring the file, and mapping information indicating correspondence relation between the objects and the storage as a part of meta data. It should be noted that the name solution unit retains the file and the mapping information indicating the correspondence relation between the file and the storage, when the meta data is stored in the storage in units of files.

The conventional distributed file system which has such a configuration operates as follows.

First, in a file access, the client inquires objects configuring a file, and a storage storing the objects to the meta server. That is, the client inquires the mapping information to the meta server in the file access.

Next, the client acquires the positions of the objects configuring the file from the mapping information which is obtained by inquiring to the meta server, and accesses to the storage which stores the objects.

The storage replies to the access from the client to send the object data.

The client acquires necessary data by accessing the storage according to a range in the file to be accessed.

However, because the meta server retains the mapping information in the forms of “file-object” and “object-storage”, there are the following problems in this method:
(1) a disk usage amount and a memory usage amount of the meta server, and a data transfer amount to the client become large;
(2) a maintenance cost for the consistence of meta data among a plurality of meta servers becomes high when a plurality of meta servers are provided;
(3) a cost in case of fault recovery becomes large because the data size which should be recovered is large; and
(4) a load centers on the meta server when the scale of the distributed file system becomes large.

Also, an example of the distributed file system in which a part of a problem due to the fact that the mapping information retained by the meta server is of a large scale can be solved is described in Non-Patent Literature 3.

In this conventional distributed file system, by carrying out grouping the storages such that a physical arrangement of the storages is reflected, and a random arrangement based on the weightings to the storages such that performance of the storages can be reflected, the problem due to the fact that the mapping information retained by the meta server is of a large scale is tried to be solved. That is, the grouping information of storages and the weighting information to the storages can be statically set in advance. Or, even if they are changed dynamically, a frequency of update can be decreased largely, compared with a frequency of file access. Therefore, basically, the positions of objects configuring a file can be calculated locally in the client, and it is not necessary to retain the mapping information in the meta server.

However, in such a method, there is a problem that the characteristic of the file cannot be reflected on the object arrangement, even if the characteristics such as the arrangement situation and performance of the storages can be reflected on the object arrangement.

In this way, the following problems exist in the conventional distributed file system.

The first problem is in that the meta data retained by the meta server of the distributed file system is large in volume. Thus, there are caused the side issues such as “a disk usage amount and a memory usage amount of a meta server, and a data transfer amount to a client become large”, “a maintenance cost of the consistence of meta data among the meta servers becomes high when the plurality of meta servers are used”, and “the cost in case of fault recovery becomes high because the size of data to be recovered is large”.

The reason is that as a part of the meta data, it is necessary to retain “a file and mapping information of objects configuring the file”, and “mapping information of an object and a storage which stores the object”.

Specifically, a rough estimation is shown below about how degree the size of the mapping information is.

For example, it is supposed that the file size is “12 GB (assuming 2 hours of video recording in HD size)”, and it is supposed that the number of the files is “10,000” and the object size is “1 MB”. Also, it is supposed that the object ID is of “64 bits” and the object server ID is of “32 bits (IPv4 address)+16 bits (port number)”. Moreover, it is supposed that “the object is retained in triple” for the purpose of the redundancy.

A data size per object (mapping information of “object−storage”) is “26 Bytes” and one file is composed of “12,000 objects”. Therefore, the size of the mapping information of “object−storage” becomes “26 Bytes*12,000=312 KB”. Also, the size of the mapping information of “file-object” becomes “64 bits(8 bytes)*12,000=96 KB”. Therefore, the size of mapping information per file is “approximately 400 KB” (“312 KB+96 KB=418 KB≈400 KB”). As a whole of the file system, the size of mapping information becomes “approximately 4 GB” (400 KB×10,000=4 GB”). It should be noted that the items of the information to be retained here are just a part of the actual system, and generally, a case that meta data of several times of the above-mentioned size becomes necessary would be present.

The second problem is in that the load is centralized on the meta servers when the scale of the distributed file system is large.

The reason is in that the look-up of the mapping information in the meta server is relatively heavy processing. In addition, because the size of the mapping information is large, a cost for the consistence maintenance becomes high when a plurality of meta servers are used. Thus, it is not possible to use many meta servers, and there is a latent possibility that the performance of the meta servers becomes a bottle neck.

The third problem is in that the characteristic of the file cannot be reflected on the object arrangement in the conventional technique for solution of the first problem.

The reason is in that in the technique, the random arrangement is made based on specific parameters such as the grouping information and the weighting information. Thus, the degree of freedom is not in the arrangement algorithm itself.

It should be noted that as the related techniques, a data management method, a data management apparatus, a program and a storage medium are disclosed in Patent Literature 1 (JP 2005-063374A).

In this related technique, the meta data can be arranged at a terminal in a home server managed by a user, and a terminal having high reliability which is managed by a provider entrusted from the user. Also, a data managing section generates and arranges the meta data on the terminal. At this time, the operating system assigns a unique identifier to the generated meta data.

### CITATION LIST

### Patent Literature

[Patent Literature 1]: JP 2005-063374A

### Non-Patent Literature

[Non-Patent Literature 1]: “Lustre Technical Project Summary” (July, 2001), by Peter J. Braam et al. of Cluster File Systems, Inc.

[Non-Patent Literature 2]: “The Panasas Active Scale Storage Cluster: Delivering Scalable High Bandwidth Storage” (In Proceedings of SC2004, November, 2004, Pittsburgh, Pa.) by D. Nagle, et al.

[Non-Patent Literature 3]: “CRUSH: Controlled, Scalable, Decentralized Placement of Replicated Data” (In Proceedings of SC2006, November 2006, Tampa, Fla.), by Sage A. Weil et al.

### SUMMARY OF THE INVENTION

The subject matter of the present invention is to provide a distributed file system in which the size of meta data retained by a meta server can be reduced and a disk usage amount, and a memory usage amount of a meta server, and a data transfer amount to a client can be reduced, by performing name solution of a file through calculation without using mapping information.

A distribution file name solution system of the present invention is provided with a plurality of object servers; a meta server; and a plurality of clients. Each of the plurality of object servers is provided with at least one object storage section for storing objects configuring a file; and an object managing section for managing the objects stored in the at least one object, storage section. The meta server is provided with at least one meta data storage section for retaining the meta data of the file; and a meta data managing section for managing the meta data stored in the at least one meta data storage section. Each of the plurality of clients is provided with a file accessing section for processing a file access to the file; a meta data accessing section for inquiring to the meta data managing section in response to the file access, and acquiring the meta data from the meta data managing section; an object position calculating section for calculating a storage position of the object without depending on mapping information, based on the meta data; and an object access section for performing object-access to the object based on the storage position of the object, and notifying the access result by the object to the file accessing section.

A distributed file name solution method of the present invention, includes: in each of a plurality of object servers, storing objects configuring a file in at least one object storage region, and managing the objects stored in the at least one object storage region, in a meta server, retaining the meta data of the file in at least one meta data storage region, and managing the meta data stored in the at least one meta data storage region; in each of the plurality of clients, processing a file access to the file, performing an inquiry to the meta server in response to the file access, and acquiring the meta data from the meta server; in each of the clients, calculating the storage positions of the objects without depending on mapping information, based on the meta data; and in the each client, performing object accessing to the objects based on the storage positions of the objects and acquiring the result of the object access.

A storage medium which stores a distributed file name solution program to make a computer to execute: a step of issuing an inquiry to the file to a meta server which manages meta data stored in at least one meta data storage region based on a file access, and acquiring the meta data from the meta server; a step of calculating a storage position of the object without using mapping information based on the meta data; a step of performing an object accesses to the object based on the storage position of the object; and a step of acquiring the object from the object server which manages the objects stored in at least one object storage region in response Lo the object access. It should be noted that the distributed file names solution program of the present invention may be stored in a storage medium and a storage.

Since the file name solution is attained through a calculation without depending on mapping information, the size of meta data retained by the meta server can be reduced, and therefore, a disk usage amount and a memory usage amount in the meta server, a data transfer amount to the client can be reduced.

### BRIEF DESCRIPTION OF THE DRAWINGS

FIG. 1 is a conceptual diagram showing a general configuration of a distributed file system when an out-of-band type virtualization is performed;

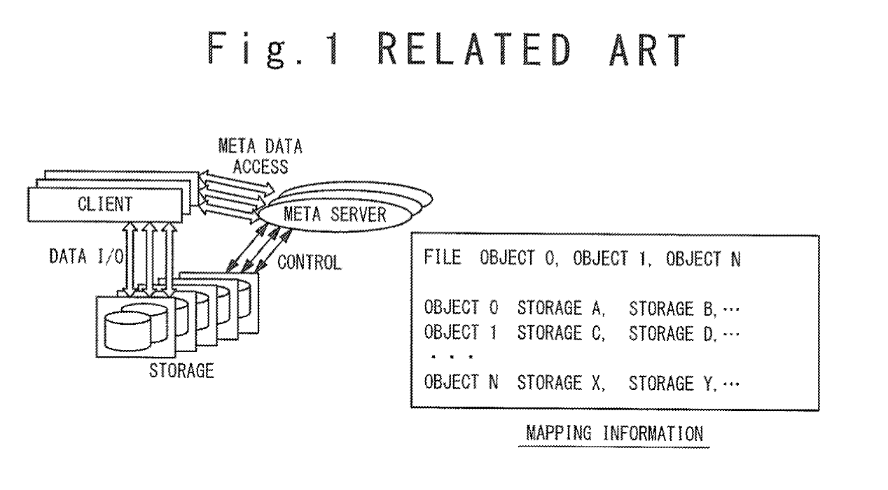

FIG. 2 is a block diagram showing a configuration of a first exemplary embodiment of the present invention;

FIG. 3 is a sequence chart showing an operation of the first exemplary embodiment of the present invention;

FIG. 4 is an example of information contained in meta data used in the present invention;

FIG. 5 is a block diagram showing a configuration of a second exemplary embodiment of the present invention; and

FIG. 6 is a diagram showing a file to be used in a specific example of a third exemplary embodiment of the present invention and an access target.

### DESCRIPTION OF EXEMPLARY EMBODIMENTS

### First Exemplary Embodiment

Hereinafter, a first exemplary embodiment of the present invention will be described with reference to the attached drawings.

### (Configuration)

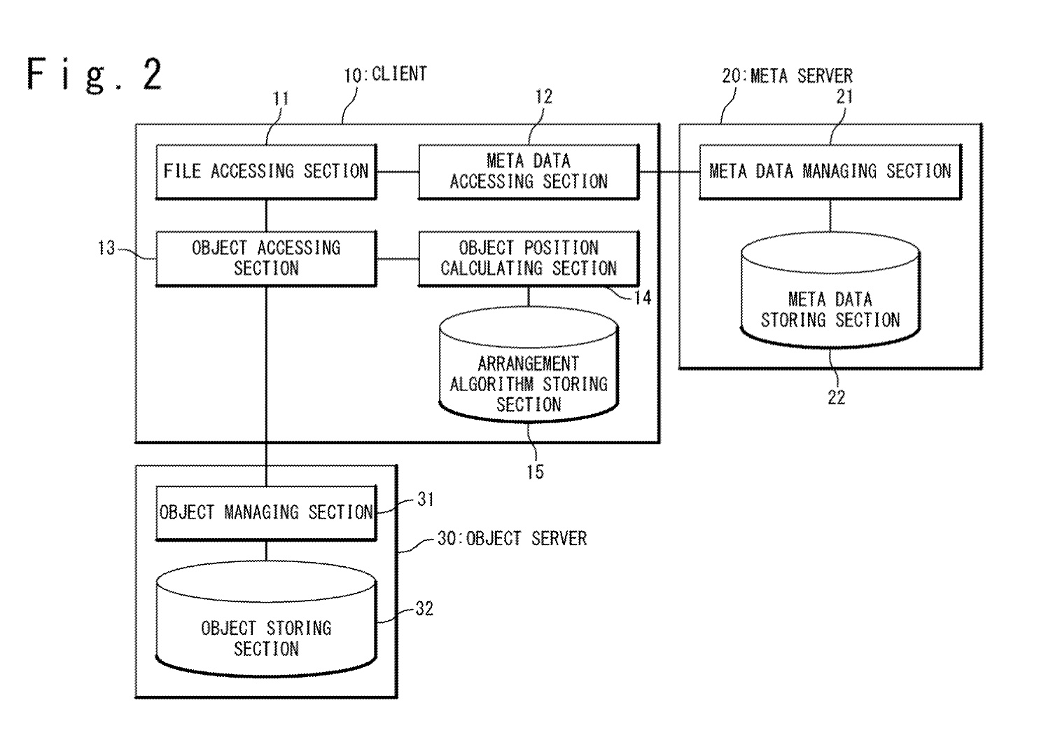

Referring to FIG. 2, a distributed file name solution system of the present invention is provided with a client 10, a meta server 20 and an object server 30.

The client 10 performs a file access. As an example of client 10, a PC (personal computer), a mobile notebook PC, a thin client terminal, a work station, a portable telephone, a car navigation system, a mobile game machine, a home-use game machine, an interactive TV, a digital tuner, a digital recorder, information home appliance, an OA (Office Automation) equipment and so on are exemplified. The client 10 may be installed into a moving body such as a vehicle, a ship, and an aircraft. However, actually, the client is not limited to these examples.

The meta server 20 retains meta data of files. As an example of the meta server 20, computers such as a PC, a thin client server, a work station, a mainframe, and a supercomputer are exemplified. However, actually, the meta server 20 is not limited to these examples.

The object server 30 stores objects configuring a file. As an example of the object server 30, computers such as a PC, a thin client server, a work station, a mainframe, and a supercomputer are exemplified. However, actually, the object server 30 is not limited to these examples.

Here, the “file” indicates a unit of data when a user or an application software (hereinafter, to be referred to as an application) performs I/O (input/output). The file is often divided into partial data, each of which is called an “object”, for the purpose of I/O throughput improvement through the parallel read and write. When the file is composed of only one object, the object and the file are same (“object”=“file”).

The client 10 is provided with a file accessing section 11, a meta data accessing section 12, an object accessing section 13, an object position calculating section 14 and an arrangement algorithm storing section 15.

The file accessing section 11 receives a file access request from the user or the application, acquires meta data of a file for the request by using the meta data accessing section 12, and acquires the objects configuring the file by an object accessing section 13 based on the meta data. Thus, the file access is performed. It should be noted that the file accessing section 11 may contain a communication interface for communication with an external unit and an input/output unit for a user operation.

The meta data accessing section 12 acquires the meta data of the file from the meta server 20 in response to a request from the file accessing section 11.

The object accessing section 13 acquires the positions of the objects configuring the file by using the object position calculating section 14 in response to a request from the file accessing section 11, and acquires the objects from the object server 30 based on the acquired positions and returns them to the file accessing section 11.

The object position calculating section 14 uses an arrangement algorithm which has been stored in the arrangement algorithm storing section 15 based on an arrangement algorithm ID and an arrangement parameter of the file which is contained in the request from the object accessing section 13, calculates the objects configuring the file to be accessed and the object server 30 which retains the objects, and returns the calculation result to the object accessing section 13. Here, the arrangement algorithm ID is an ID showing a random algorithm. Also, the arrangement parameter is a seed value to be supplied to the random algorithm. That is, the arrangement parameter is a parameter of the arrangement algorithm. However, actually, the algorithm and the parameter are not limited to these examples.

The arrangement algorithm storing section 15 stores arrangement algorithms. In this example, the arrangement algorithm storing section 15 relates and stores the arrangement algorithm ID and the arrangement algorithm.

The meta server 20 contains a meta data managing section 21 and a meta data storing section 22.

The meta data managing section 21 acquires the meta data of the accessed file from the meta data storing section 22 in response to a request from the meta data accessing section 12 and returns the acquired meta data to the meta data accessing section 12.

The meta data storing section 22 stores the meta data of the file. At least one meta data storing section 22 exists.

The object server 30 contains an object managing section 31 and an object storing section 32.

The object managing section 31 acquires objects from the object storing section 32 in response to a request from the object accessing section 13, and returns the acquired objects to the object accessing section 13.

The object storing section 32 stores objects. At least one object storing section 32 exists.

As examples of the file accessing section 11, the object position calculating section 14, the meta data managing section 21 and the object managing section 31, a processing unit such as a CPU (Central Processing Unit), and a microprocessor (microprocessor), or a semiconductor integrated circuit (IC) which has a similar function or the program to make a computer execute each function and so on are exemplified. However, actually, the present invention is not limited to these examples.

As examples of the meta data accessing section 12, and the object accessing section 13, network adapters such as an NIC (Network Interface Card), communication units such as an antenna, and communication ports such as connection opening (connector) are exemplified. As an example of communication line used by the meta data accessing section 12 and the object accessing section 13, the Internet, a LAN (Local Area Network), a wireless LAN (Wireless LAN), a WAN (Wide Area Network), backbone (Backbone), a community antenna television system (CATV) line, a fixation telephone network, a carrying telephone network, a WiMAX (IEEE 802.16a), a 3G (3rd Generation), a leased circuit (lease line), an IrDA (Infrared Data Association), a Bluetooth (registered trademark), a serial communication line, a data bus and so on are exemplified. Also, when exchanging a file and data, it is thought of that the file and data are stored in a USB memory and a storage medium (medium) such as DVD, and the file and data are exchanged through the storage medium (medium). In this case, as examples of the meta data accessing section 12 and the object accessing section 13, the connection opening (connector) such as the USB port and readers such as the DVD drives are exemplified. However, actually, the present invention is not limited to these examples.

As an examples of the arrangement algorithm storing section 15, the meta data storing section 22 and the object storing section 32, external storing units (storages) such as HDD (Hard Disk Drive) and SSD (Solid State Drive) are assumed. Besides, as examples of the arrangement algorithm storing section 15, the meta data storing section 22 and the object storing section 32, semiconductor memory units such as RAM (Random Access Memory), ROM (Read Only Memory) or flash memory, and a removable disk and a storage medium (medium) such as DVD (Digital Versatile Disk) and SD memory card (Secure Digital memory card) are exemplified. As examples of the arrangement algorithm storing section 15, the meta data storing section 22 and the object storing section 32, a storage installed in a peripheral device (external HDD, and so on,) and an external server (Web server, a file server and so on), or DAS (Direct Attached Storage), FC-SAN (Fibre Channel-Storage Area Network), NAS (Network Attached Storage), IP-SAN (IP-Storage Area Network) are exemplified in addition to a storage device built in a computer main body. However, actually, the present invention is not limited to these examples.

### (Operation)

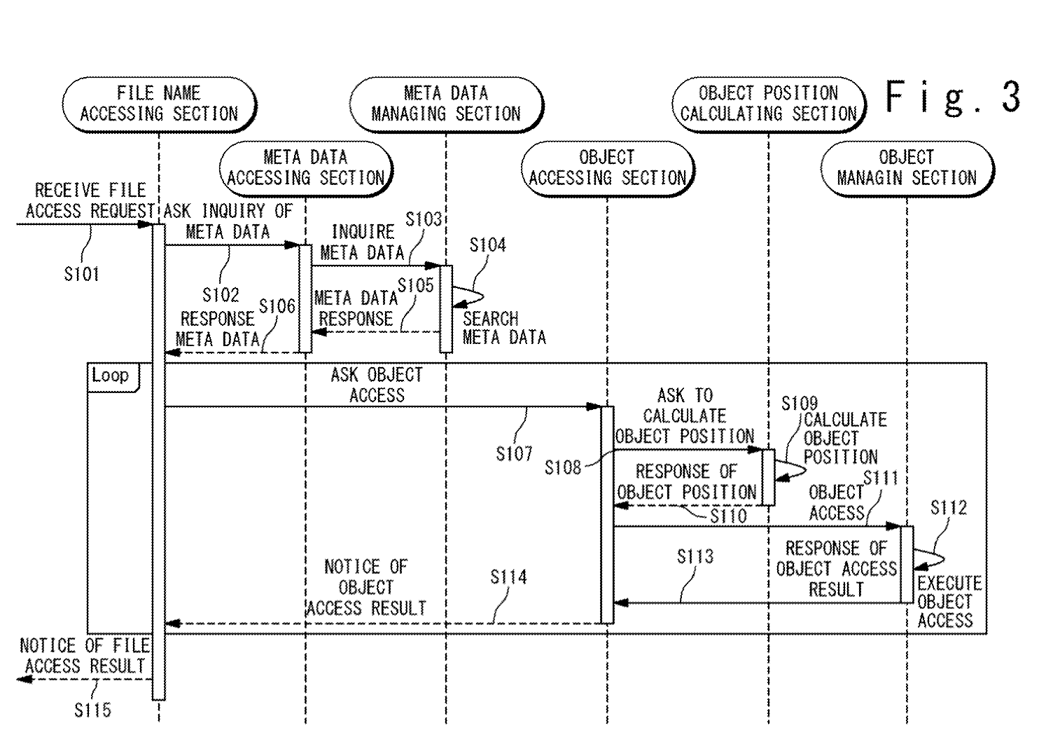

Next, an operation of the whole of the present exemplary embodiment will be described in detail with reference to the sequence chart of FIG. 3.

(1) Step S101

First, the file accessing section 11 receives a file access request from the user. For example, the file accessing section 11 receives the file access request from a user application through a file system interface.

(2) Step S102

The file accessing section 11 controls the meta data accessing section 12 to request the meta data of the corresponding file in response to the file access request.

(3) Step S103

Next, the meta data accessing section 12 requests the meta data to the meta data managing section 21.

(4) Step S104

Next, the meta data managing section 21 retrieves the meta data from the meta data storing section 22. That is, the meta data managing section 21 discovers the meta data from a group of meta data which have been stored in the meta data storing section 22.

It should be noted that when the meta data is not found out, the meta data managing section 21 returns an error indicating that the file is not found out. For example, when the meta data is not found out, the meta data managing section 21 returns an error of ENOENT in case of POSIX.

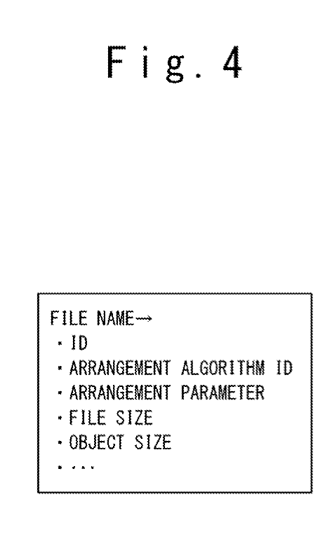

In this example, as shown in FIG. 4, it is supposed that the meta data of the file contains the meta data such as a size, an owner, access right, production time and so on, in addition to an arrangement algorithm ID and an arrangement parameter used in the arrangement algorithm.

(5) Step S105

When the meta data is found out, the meta data managing section 21 sends the meta data to the meta data accessing section 12.

(6) Step S106

When receiving the meta data from the meta data managing section 21, the meta data accessing section 12 sends the meta data to the file accessing section 11.

(7) Step S107

The file accessing section 11 issues an object access request to the object accessing section 13 when acquiring the meta data of the file. Here, the file accessing section 11 transmits the arrangement algorithm ID and the arrangement parameter which are contained in the meta data acquired from the meta server 20 together with the object access request.

(8) Step S108

In response to the object access request, the object accessing section 13 issues a calculation request of storage position of the object (object server ID) to the object position calculating section 14 with the arrangement algorithm ID and the arrangement parameter.

(9) Step S109

The object position calculating section 14 acquires the arrangement algorithm from the arrangement algorithm storing section 15 based on the arrangement algorithm ID from the object accessing section 13, executes the algorithm by setting the arrangement parameter, and calculates the identification information (object ID) of the object as the access target and the storage position (object server ID) of the object. In this example, the object position calculating section 14 calculates an ID of the object as the access target and an ID of the object server 30 storing the object, based on the arrangement algorithm.

(10) Step S110

The object position calculating section 14 sends the identification information (object ID) of the object as the access target and the storage position (object server ID) of the object to the object accessing section 13. In this example, the object position calculating section 14 sends the object ID as the access target and the ID of the object server 30 which stores the objects, to the object accessing section 13.

(11) Step S111

When acquiring the identification information (object ID) of the object as the access target and the storage position (object server ID) of the object, the object accessing section 13 specifies the object ID as the access target to the object managing section 31 of the object server 30 storing objects, and accesses the object (object access).

(12) Step S112

The object managing section 31 performs the access to the object stored in the object storing section 32. For example, the object managing section 31 performs processing such as reference to data, and acquisition, update and deletion of the data, to the object which has been stored in the object storing section 32, in response to the object access from the object accessing section 13.

(13) Step S113

The object managing section 31 sends the processing result of the access to the object to the object accessing section 13

(14) Step S114

Lastly, the object accessing section 13 notifies the access processing result to the object to the file accessing section 11.

(15) Step S115

After completion of the access to a necessary part (object as the access target), the file accessing section 11 sends a notice of a result of the file access to the user as a file access source. That is, the file accessing section 11 sends a notice of the result of the file access to the user as the file access source based on the access result to the object.

Until completion of the access to the necessary part after step S115, the control flow repeats step S107 to step S114.

In this example, the description is made that the calculation of the storage position of the object at step S108 and the object access at step S111 are repeated. However, the present invention is not limited to this example. Depending on the size of the file, the characteristics of the arrangement algorithm and so on, the arrangement calculation of all the objects configuring the file is performed, and then the object access may be repeated.

### (Features)

In the present exemplary embodiment, the storage positions of objects configuring the file are not stored in the meta data of the meta server 20 as the mapping information, but only the arrangement algorithm ID and the parameter which are related to the file are in the meta data. The storage position is calculated by the object position calculating section 14 on the client side. Therefore, the size of meta data retained by the meta server 20 can be reduced, and a disk usage amount, a memory usage amount and a data transfer amount to the client in the meta server 20 and so on can be reduced.

Also, in case to perform look-up (name solution) of the objects configuring the file and the storage positions, the present exemplary embodiment is configured to determine the objects and the storage positions by the calculation without using the mapping information. Therefore, even when the distributed file system is made large in scale by increasing the number of the clients, the load of the meta server 20 can be suppressed.

Also, the present exemplary embodiment is configured to retain the arrangement algorithm ID and the parameter for every file. Therefore, a method of arranging the object can be devised for every file. That is, the characteristic of the file can be reflected on the object arrangement.

### Second Exemplary Embodiment

Next, a second exemplary embodiment of the present invention will be described below.

### (Configuration)

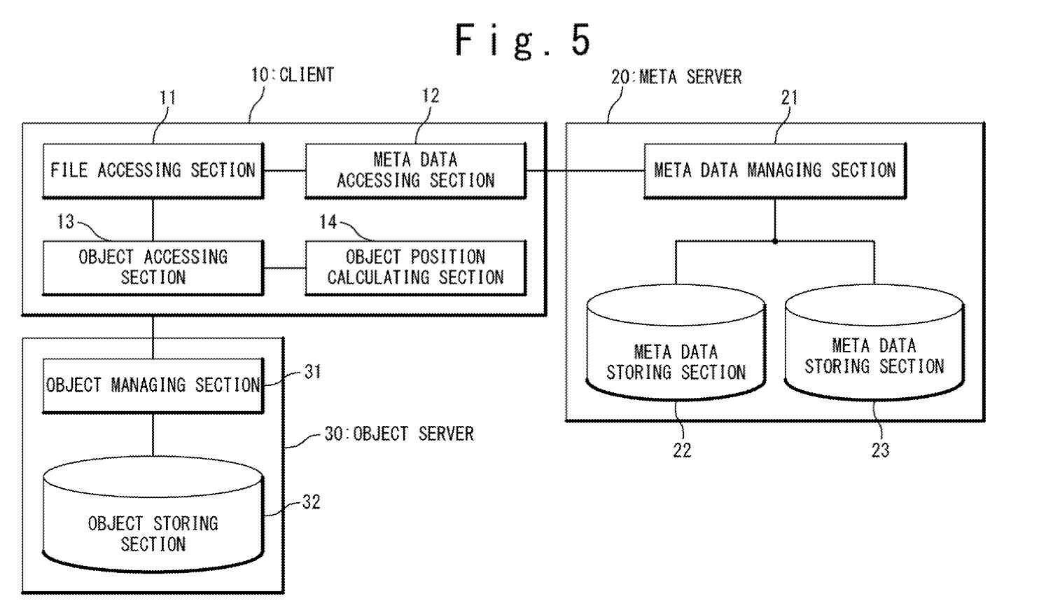

Referring to FIG. 5, the distributed file name solution system of the present invention is provided with the client 10, the meta server 20 and the object server 30.

The client 10 is provided with the file accessing section 11, the meta data accessing section 12, the object accessing section 13 and the object position calculating section 14.

The file accessing section 11, the meta data accessing section 12, the object accessing section 13 and the object position calculating section 14 are the same as those of the first exemplary embodiment.

The meta server 20 is provided with the meta data managing section 21, the meta data storing section 22 and the arrangement algorithm storing section 23.

The meta data managing section 21 and the meta data storing section 22 are the same as those of the first exemplary embodiment.

The arrangement algorithm storing section 23 stores the arrangement algorithms. In this example, the arrangement algorithm storing section 23 relates and stores the arrangement algorithm ID and the arrangement algorithm. That is, the arrangement algorithm storing section 23 is that same as the arrangement algorithm storing section 15 in the first exemplary embodiment.

The object server 30 is provided with the object managing section 31 and the object storing section 32.

The object managing section 31 and the object storing section 32 are the same as those of the first exemplary embodiment.

Referring to FIG. 5, the present exemplary embodiment is different from the first exemplary embodiment in that the arrangement algorithm storing section is provided in the client but the meta server. It should be noted that the arrangement algorithm storing section 23 may be contained in the meta server storing section 22.

As for the operation of the whole of the present exemplary embodiment, in the first exemplary embodiment, the arrangement algorithm ID and the parameter are acquired from the meta server 20, and the storage position of the object is calculated by using the arrangement algorithm on the client side. However, in the present exemplary embodiment, the arrangement algorithm is acquired from the meta server 20. This difference is present between the first and second exemplary embodiments but there is no large difference in sequence between these exemplary embodiments.

### (Operation)

Referring to a sequence chart of FIG. 3, the operation of the whole of the present exemplary embodiment will be described.

The operation at step S101 to step S104 is the same as that of the first exemplary embodiment.

At step S105, when the meta data is found out, the meta data managing section 21 sends the meta data and the arrangement algorithm corresponding to the arrangement algorithm ID which is contained in the meta data, to the meta data accessing section 12. In this example, the meta data managing section 21 acquires the arrangement algorithm from the arrangement algorithm storing section 23 based on the arrangement algorithm ID which is contained in the meta data, and sends the arrangement algorithm with the meta data to the meta data accessing section 12.

At step S106, when receiving the meta data and the arrangement algorithm from the meta data managing section 21, the meta data accessing section 12 sends the meta data and the arrangement algorithm to the file accessing section 11.

At step S107, when acquiring the meta data of the corresponding file, the file accessing section 11 issues an object access request to the object accessing section 13. At this time, the file accessing section 11 sends the arrangement algorithm and the arrangement parameter which are earlier acquired from the meta server 20, together with the object access request.

At step S108, the object accessing section 13 issues the calculation request of the storage position (object server ID) of the object to the object position calculating section 14, together with the arrangement algorithm and the arrangement parameter, in response to the object access request.

At step S109, when receiving the arrangement algorithm and the arrangement parameter from the object accessing section 13, the object position calculating section 14 executes the algorithm by setting the arrangement parameter, and calculates the identification information (object ID) of the object as the access target and the storage position (object server ID) of the object.

The operation of step S110 to step S115 is the same as that of the first exemplary embodiment.

### (Features)

In the present exemplary embodiment, because the arrangement algorithm is stored on the side of the meta server 20, the addition and extension of the arrangement algorithm can be easily performed, as compared with the case that the arrangement algorithm is stored on the side of the client.

### Third Exemplary Embodiment

Below, a third exemplary embodiment of the present invention will be described. Up to this point, it is implicitly supposed that the object size is a fixed length. However, in the present exemplary embodiment, the above-mentioned technique, in which the objects configuring the file and the storage positions of the objects are determined through calculation, is applied to the object size, too, and the object size is calculated.

### (Operation)

Next, by using a specific example, an operation of the present exemplary embodiment will be described.

In this example, in the operation described in the first exemplary embodiment, the operation of step S107 to step S110 in the sequence chart of the FIG. 3 will be described by using the specific example.

The operation of step S101 to step S106 is the same as those of the other exemplary embodiments.

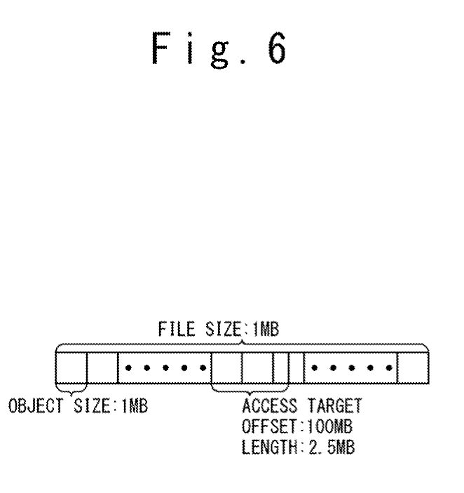

As shown in FIG. 6, the file with the size of “1 GB” is divided into the objects with the size of “1 MB” which are stored in an object server group. In this case, it is supposed that a read access to a region for the length of “2.5 MB” from the position with the offset of “100 MB” is performed. In this case, it is supposed that the arrangement algorithms are stored at random, i.e. the objects are stored in the object server 30 at random.

At step S107, when acquiring the meta data of the file, the file accessing section 11 specifies the “offset (100 MB)” and the “length (2.5 MB)” to the access target in the file and issues an object access request to the object accessing section 13. That is, the offset and the length are contained in the object access request. At this time, the file accessing section 11 sends the arrangement algorithm ID, the arrangement parameter, the file ID, the file size, the object size, which are contained in the meta data acquired from the meta server 20, together with the object access request.

At step S108, the object accessing section 13 issues a calculation request of the position of the object to the object position calculating section 14 in response to the object access request. At this time, he object accessing section 13 sends the arrangement algorithm ID, the arrangement parameter, the file ID, the file size, the object size, the offset and the length, together with the calculation request of the position of the object. It should be noted that the arrangement algorithm ID, the arrangement parameter, the file ID, the file size, the object size, the offset and the length may be contained in the calculation request of the position of the object.

At step S109, the object position calculating section 14 acquires a random algorithm specified as the arrangement algorithm in response to the calculation request of the position of the object from the arrangement algorithm storing section 15, executes the random algorithm by setting the parameter to the random algorithm, and calculates the object ID and the object server ID from the file ID, the object size, and the offset and the length in the access target in the file.

Specifically, the object position calculating section 14 can calculate the number of objects configuring the file from the file size and the object size. In addition, by setting the object ID to be “the file ID+the order in file”, the object position calculating section 14 acquires the object size and the file ID which is contained in the meta data, acquires the offset and length of the access target together with the calculation request of the position of the object from the object accessing section 13, and calculates the object ID from the file ID, the object size, and the offset and length in the access target. Or, the object position calculating section 14 may set a surplus when dividing the n^{th} value in a pseudo-random number sequence generated by the random algorithm by the number of object servers, when an order in the file of the object as the access target is n.

Here, the object position calculating section 14 calculates an order of the object in the file from the “object size (1 MB)”, the “offset (100 MB)” and the “length (2.5 MB)”. That is, when the object at the head in the file is the 0^{th} object, the orders of the objects as the access target in the files are the “100^{th}”, the “101^{st}”, and the “102^{nd}”, respectively. Also, the respective object IDs are “file ID+100”, “file ID+101”, and “file ID+102”.

At step S110, the object position calculating section 14 sends the object ID obtained through such a calculation, and the ID of the object server which stores the object, to the object accessing section 13.

The operation of step S111 to step S115 is the same as those of the other exemplary embodiments. (Features)

In the present exemplary embodiment, to determine the object size through the calculation, the characteristic of the file can be more flexibly. reflected on the object arrangement.

### SUMMARY

As mentioned above, the present invention relates to the distributed file name solution system, the distributed file name solution method, and the program for solution of distributed tile names, in which the load of the meta server, and communications traffic among the client and the meta server can be reduced.

Conventionally, “mapping information of a file and objects configuring the file” and “mapping information of an object and a storage which stores the object” are contained in the meta data retained in the meta server of the distributed file system. Therefore, there is a problem that the size is large. Also, the look-up of the mapping information is relatively heavy processing and there is a problem that the meta server is easy Lo become a bottle neck in performance. Also, there is another problem that the characteristic of the file cannot be reflected on the object arrangement, when a name solution is performed through calculation.

The subject matter of the present invention is to provide a name solution system in the distributed file system in which the meta data retained by the meta server can be reduced by determining name solution of a file through calculation without using the mapping information, and in which a disk usage amount, and a memory usage amount of the meta server, and a data transfer amount to the client can be reduced.

Another subject matter of the present invention is to provide a name solution system in the distributed file system, in which the load of the meta server is off-loaded to the side of the client by determining name solution of a file through calculation without using the mapping information, and the load of the meta server can be suppressed when configuring a relatively large-scale file system compared with the conventional technique.

Another subject matter of the present invention is to provide a name solution system in the distributed file system, in which the characteristic of the file can be reflected on the object arrangement by making the arrangement algorithm of the file that selectable.

In the distributed file name solution system of the present invention, an object arrangement algorithm ID and a parameter to the algorithm are retained for every file, instead of retaining mapping information in the meta data. Also, the object position calculating section on the side of the client calculates the positions of the objects in the object server which stores the objects and the object IDs configuring the file. Thus, the problem can be solved.

The distributed file name solution system is a name solution system in the distributed file system. The distributed file name solution system is provided with a plurality at object servers, a meta server, and a plurality of clients. The plurality of object servers includes at least one object storage section configured to store objects configuring a file; and an object managing section configured to manage the objects. The meta server includes at least one of meta data storage section configured to retain the meta data of the file and a meta data managing section configured to manage the meta data. The plurality of clients includes a file accessing section configured to handle a file access from a user, a meta data accessing section configured to manage access to the meta server, an object accessing section configured to manage object access, and an object position calculating section configured to calculate an object position.

At this time, the object position calculating section determines IDs of objects configuring the file and a storage position of the object (e.g. the object server ID) through calculation using a specified object arrangement algorithm and a parameter corresponding to the algorithm.

Also, the distributed file name solution system retains the object arrangement algorithms and the parameters in the arrangement algorithm storing section of the client.

Also, the distributed file name solution system retains object arrangement algorithms and the parameters in the arrangement algorithm storing section (or the meta data storing section) of the meta server.

Also, the distributed file name solution system can set the object arrangement algorithm for every file.

Also, the distributed file name solution system is provided with the object position calculating section and the arrangement algorithm storing section, and determines the object configuring a file and the storage position thereof (e.g. the object server ID) through calculation on the side of the client by using the arrangement algorithm ID and the arrangement parameter corresponding to the file contained in the meta data. The subject matter of the present invention can be achieved by adopting such a configuration and off-loading a part of the name solution processing performed in the conventional meta server to the side of the client.

The distributed file names solution program is a program to make a computer execute an operation (the distributed file name solution method) in the distributed file name solution system of the present invention. It should be noted that the distributed file name solution program can be stored in a storage medium. In this case, the distributed file names solution program is read from the storage medium by a processor such as a CPU and is executed.

The first effect of the present invention is in that the meta data retained by the meta server can be reduces and a disk usage amount and a memory usage amount of the meta server, and a data transfer amount to the client can be reduced. This is because the file name solution can be performed through the calculation without using the mapping information.

The second effect of the present invention is in that the load of the meta server can be suppressed even when the distributed file system is made large in scale, i.e., the number of clients is increased. This is because the load of the meta server can be off-loaded to the side of the client by determining the file name solution through the calculation without using the mapping information.

The third effect of the present invention is in that the file characteristic can be reflected on the object arrangement. This is because the algorithm used for the calculation of the file name solution can be set for every file.

The present invention can be applied to the name solution in the distributed file system which is provided with a plurality of object servers and a plurality of clients.

The exemplary embodiments of the present invention have been described in detail, but the present invention is not limited to the above-mentioned exemplary embodiments. Various modifications which do not deviate from the scope of the present invention are contained in the present invention.

The present Patent application claims a priority on convention based on Japan Patent Application No. 2009-002333. The disclosure thereof is incorporated herein by reference.

1. A distribution file name solution system comprising:
a plurality of object servers;
a meta server; and
a plurality of clients, and wherein each of said plurality of object servers comprises:
a object storage section configured to store objects configuring a file; and
an object managing section configured to manage the objects stored in said object storage section,
wherein said meta server comprises:
a meta data storage section configured to retain meta data of said file; and
a meta data managing section configured to manage the meta data stored in said meta data storage section, and
wherein each of said plurality of clients comprises:
a file accessing section configured to perform a file access to said file;
a meta data accessing section configured to request said meta data to said meta data managing section in response to the file access, and acquire said meta data from said meta data managing section;
an object position calculating section configured to acquire an object arrangement algorithm and an arrangement parameter from said meta data to calculate a storage position of each of said objects based on said meta data; and
an object access section configured to access to said object based on the storage position of said object, and notify the accessing result to said object to said file accessing section.

2. The distributed file name solution system according to claim 1, wherein said object position calculating section acquires said object arrangement algorithm and said arrangement parameter corresponding to said object arrangement algorithm, which are specified based on said meta data, executes said object arrangement algorithm by setting said arrangement parameter, and calculates an identification of said object to specify said object, and an identification of said object server to specify said object server in which object has been stored, and
wherein said object accessing section accesses said object server in which said object has been stored based on said object server identification, to acquire said object based on said object identification.

3. The distributed file name solution system according to claim 2, wherein each of said plurality of clients further comprises an arrangement algorithm storage section configured to store object arrangement algorithms,
wherein said object position calculating section acquires an identification of said object arrangement algorithm and said arrangement parameter from said meta data, acquires said object arrangement algorithm from said arrangement algorithm storage section based on the identification of said object arrangement algorithm, and executes said object arrangement algorithm by setting said arrangement parameter.

4. The distributed file name solution system according to claim 2, wherein said meta server further comprises:
an arrangement algorithm storage section configured to store object arrangement algorithms,
wherein said meta data managing section acquires said meta data from said meta data storage section in response to an inquiry from said meta data accessing section, acquires said object arrangement algorithm from said arrangement algorithm storage section based on an identification of said object arrangement algorithm identification which is contained in said meta data, and sends said object arrangement algorithm together with said meta data to said meta data accessing section, and
wherein said object position calculating section acquires said arrangement parameter from said meta data and executes said object arrangement algorithm by setting said arrangement parameter.

5. The distributed file name solution system according to claim 1, wherein said file accessing section acquires, when acquiring said meta data, an identification of said file and an object size from said meta data, specifies an offset and a length of an access target in said file, to send an object access request including the offset and the length of the access target in the file, together with said file identification and the object size to said object accessing section,
wherein said object accessing section sends a calculation request of the storage position of said object to said object position calculating section in response to said object access request, together with said file identification, the object size, the offset and the length, and
wherein said object position calculating section acquires said file identification, the object size, the offset and the length in response to the calculation request of the storage position of said object, calculates an order of said object as the access target in the file from the object size, the offset and the length, and calculates said object identification from said file identification and the calculated order to send to said object accessing section.

6. A distributed file name solution method comprising:
in each of a plurality of object servers, storing objects configuring a file in an object storage region, and managing the objects stored in said object storage region;
in a meta server, retaining meta data of said file in a meta data storage region, and managing said meta data stored in said meta data storage region;
in each of said plurality of clients, issuing an inquiry to said meta server in response to the file access, and acquiring said meta data from said meta server;
in said client, acquiring an object arrangement algorithm and an arrangement parameter from said meta data to calculate a storage position of said object based on said meta data; and
in said client, accessing to said object based on the calculated storage position of said object and acquiring the result of said object access.

7. The distributed file name solution method according to claim 6, further comprising:
in said client, acquiring said object arrangement algorithm specified based on said meta data and said arrangement parameter corresponding to said object arrangement algorithm;
in said client, executing said object arrangement algorithm by setting said arrangement parameter, and calculating an identification of said object to specify said object and an identification of said object server to specify said object server in which said object has been stored; and
in said client, accessing said object server in which said object has been stored, based on said object server identification, and acquiring said object based on said object identification.

8. The distributed file name solution method according to claim 7, further comprising:
in said client, retaining object arrangement algorithms in an arrangement algorithm storage region;
in said client, acquiring the identification of said object arrangement algorithm and said arrangement parameter from said meta data;
in said client, acquiring said object arrangement algorithm from said arrangement algorithm storage region based on the identification of said object arrangement algorithm; and
in said client, executing said object arrangement algorithm by setting said arrangement parameter.

9. The distributed file name solution method according to claim 7, further comprising:
in said meta server, retaining object arrangement algorithms in an arrangement algorithm storage region;
in said meta server, acquiring said meta data from said meta data storage region in response to an inquiry from said client;
in said meta server, acquiring said object arrangement algorithm from said arrangement algorithm storage region based on an identification of said object arrangement algorithm identification which is contained in said meta data;
in said meta server, sending said object arrangement algorithm together with said meta data to said client;
in said client, acquiring said arrangement parameter from said meta data; and
in said client, executing said object arrangement algorithm by setting said arrangement parameter.

10. The distributed file name solution method according to claim 6, wherein further comprising:
in said client, when acquiring said meta data, acquiring an identification of said file and an object size from said meta data;
in said client, issuing an object access request by specifying an offset and a length of an access target in said file together with said file identification and the object size;
in said client, issuing an object position calculation request together with said file identification, the object size, an offset and a length in response to an object access request;
in said client, acquiring said file identification, the object size, the offset and the length in response to the object position calculation request;
in said client, calculating an order of said object as an access target in said file from the object size, the offset and the length; and
in said client, calculating said object identification of said object from the order in said file and said file identification.

11. A computer-readable non-transitory storage medium which stores a computer-executable program code to attain a distributed file name solution method which comprises:
performing a file access to a file;
issuing an inquiry to a meta server which manages meta data stored in a meta data storage region based on the file access, and acquiring said meta data from said meta server;
acquire an object arrangement algorithm and an arrangement parameter from said meta data to calculate a storage position of an object based on said meta data;
performing an object access to said object based on the storage position of said object; and
acquiring said object from said object server which manages objects stored in an object storage region in response to the object access.

12. The computer-readable non-transitory storage medium according to claim 11,
wherein said distributed file name solution method further comprises:
acquiring said object arrangement algorithm specified based on said meta data and said arrangement parameter corresponding to said object arrangement algorithm;
executing said object arrangement algorithm by setting said object arrangement parameter, and calculating an identification of said object to specify said object and an identification of said object server to specify said object server in which said object has been stored;
accessing to said object server in which said object has been stored, based on said object server identification; and
acquiring said object based on said object identification.

13. The computer-readable non-transitory storage medium according to claim 12,
wherein said distributed file name solution method further comprises:
retaining arrangement algorithms in an arrangement algorithm storage region;
acquiring the identification of said object arrangement algorithm and an arrangement parameter from said meta data;
acquiring an object arrangement algorithm from said arrangement algorithm storage region based on said arrangement algorithm identification; and
executing said object arrangement algorithm by setting said arrangement parameter.

14. The computer-readable non-transitory storage medium according to claim 12,
wherein said distributed file name solution method further comprises:
acquiring said meta data and an object arrangement algorithm from said meta server;
acquiring said arrangement parameter from said meta data; and
executing said object arrangement algorithm by setting said arrangement parameter.

15. The computer-readable non-transitory storage medium according to claim 11,
wherein said distributed file name solution method further comprises:
acquiring a file identification and an object size from said meta data when acquiring said meta data;
issuing an object access request by specifying an offset and a length of an access target in said file together with a file identification and the object size;
issuing a calculation request of a position of said object together with said file identification, the object size, the offset and the length in response to said object access request;
acquiring said file identification, the object size, the offset and the length in response to the calculation request of the position of said object;
calculating an order of said object as an access target in said file from said the size, the offset and the length; and
calculating said object identification from the order in said file and said file identification.
